(19) United States
(12) Patent Application Publication
(10) Pub. No.: US 2025/0123496 A1
(43) Pub. Date: Apr. 17, 2025

(54) QUICK LOCK AND RELEASE ATTACHMENT MECHANISM FOR GLASSES, GOGGLES, AND EYEWEAR

(71) Applicant: Spoke & Piston, San Diego, CA (US)

(72) Inventors: Dennis Cabingao Tan, San Diego, CA (US); Angie Lee Kosasih, San Diego, CA (US); Michael D. Young, Lakeside, CA (US)

(73) Assignee: Spoke & Piston, San Diego, CA (US)

(21) Appl. No.: 18/913,697

(22) Filed: Oct. 11, 2024

Related U.S. Application Data
(60) Provisional application No. 63/589,572, filed on Oct. 11, 2023.
(60) Provisional application No. 63/705,982, filed on Oct. 10, 2024.

(51) Int. Cl. G02C 3/00

(52) U.S. Cl. CPC G02C 3/003; G02C 2200/02; G02C 2200/06

(57) ABSTRACT

Attachment mechanisms for eyewear are shown and disclosed. In some embodiments, the eyewear includes a lens and a lens locking element fixedly attached to, or formed with the lens. The eyewear additionally includes a frame having at least one surface that contacts at least a portion of a perimeter of the lens. The eyewear additionally includes a frame locking assembly that includes a locking base attached to, or formed with, the frame. The frame locking assembly additionally includes a frame locking element that moves relative to the locking base. The lens locking element and the frame locking assembly are positioned such that, when the at least a portion of a perimeter of the lens contacts the at least one surface, the frame locking element mechanically engages the lens locking element to removably secure the lens to the frame.

### CROSS REFERENCE TO RELATED APPLICATIONS

This application claims the benefit of U.S. Provisional Patent Application No. 63/589,572 filed on Oct. 11, 2023 and entitled “Quick Lock and Release Attachment Mechanism for Glasses, Goggles, and Eyewear” and U.S. Provisional Patent Application No. 63/705,982 filed on Oct. 10, 2024 and entitled “Quick Lock and Release Attachment Mechanism for Glasses, Goggles, and Eyewear.” The complete disclosures of the above applications are hereby incorporated by reference for all purposes.

### BACKGROUND

In the domain of eyewear design and use, a long-standing challenge has been the inconvenience associated with changing between different lens types. Traditional eyewear systems and designs have historically lacked the user-friendly mechanisms essential for ease of lens interchangeability, a limitation that has affected individuals reliant on prescription eyeglasses for example because they require both clear and sunglass lenses to adapt to varying lighting conditions.

Historically, eyewear users faced inconvenience when transitioning between lenses to suit changing environments. Carrying multiple pairs of glasses was often necessary, and the permanently attached lenses complicated cleaning efforts. This inconvenience hindered user flexibility.

Furthermore, traditional eyewear attachment methods, often intricate and non-intuitive, failed to cater to the diverse needs of users across different lifestyles and activities. Wearers in need of prescription lenses, for instance, struggled to find a convenient way to shift between clear, prescription lenses for indoor use and sunglasses, prescription lenses for outdoor activities.

The limitations inherent in the existing eyewear landscape have underscored the pressing need for a new solution that prioritizes seamless lens switching. What is needed, therefore, is a quick lock and release eyewear attachment mechanism that enables users to easily interchange, switch, or clean lenses.

### BRIEF DESCRIPTION OF THE DRAWINGS

For a better understanding of the invention, and to show how the same may be carried into effect, reference will now be made, by way of example, to the accompanying drawings, in which:

FIG. 1 is an isometric view of goggles having an example of an attachment mechanism of the present disclosure;

FIG. 2 is a partial isometric view of the goggles of FIG. 1 shown with a lens detached from a goggles frame;

FIG. 3 is a partial isometric view of the lens of FIG. 2;

FIGS. 4-5 are partial isometric views of attaching the lens to the goggles frame via the attachment mechanism of FIGS. 1-3;

FIGS. 6-7 are partial views showing an example of a lens locking element of the lens engaging with an example of a frame locking element of a frame locking assembly of the attachment mechanism of FIGS. 1-5;

FIGS. 8-10 are partial views showing an example of a lens locking element of the lens engaging with an example of a frame locking element of a frame locking assembly of another example of an attachment mechanism of the present disclosure;

FIG. 11 is an exploded view of an example of a frame locking assembly of the attachment mechanism of FIGS. 8-10;

FIG. 12 is a partial isometric view showing the lens detached from the goggles frame and an additional example of an attachment mechanism of the present disclosure;

FIGS. 13-14 are partial isometric views of attaching the lens to the goggles frame via the attachment mechanism of FIG. 12;

FIGS. 15-17 are partial sectional views showing an example of a lens locking element of the lens engaging with an example of a frame locking element of a frame locking assembly of the attachment mechanism of FIGS. 12-14;

FIG. 18 is a partial isometric view showing the lens detached from the goggles frame and yet another example of an attachment mechanism of the present disclosure;

FIGS. 19-20 are partial isometric views of attaching the lens to the goggles frame via the attachment mechanism of FIG. 18;

FIGS. 21-23 are partial sectional views showing an example of a lens locking element of the lens engaging with an example of a frame locking element of a frame locking assembly of the attachment mechanism of FIGS. 18-20;

FIG. 24 is an isometric view of an example of visor glasses having a further example of an attachment mechanism of the present disclosure;

FIG. 25 is a partial isometric view showing the lens detached from the visor frame of the visor glasses of FIG. 24;

FIGS. 26-28 are partial sectional views showing an example of a lens locking element of the lens engaging with an example of a frame locking element of a frame locking assembly of the attachment mechanism of FIGS. 24-25;

FIG. 29 is a partial isometric view showing the lens detached from the visor frame of the visor glasses of FIG. 24 and an additional example of an attachment mechanism of the present disclosure; and

FIGS. 30-31 are partial sectional views showing an example of a lens locking element of the lens engaging with an example of a frame locking element of a frame locking assembly of the attachment mechanism of FIG. 29.

### DETAILED DESCRIPTION

The systems and designs disclosed herein transform the way we perceive and interact with eyewear, spanning a wide range of applications, including prescription glasses, sunglasses, ski masks, goggles, helmets, visor glasses (or eye visors), augmented reality headsets, eye and/or face shields, safety glasses, safety goggles, and more. One of the core concepts centers on a unique lens attachment mechanism that enhances user convenience and versatility—the quick lock and release attachment mechanism for eyewear provides ease of use for users.

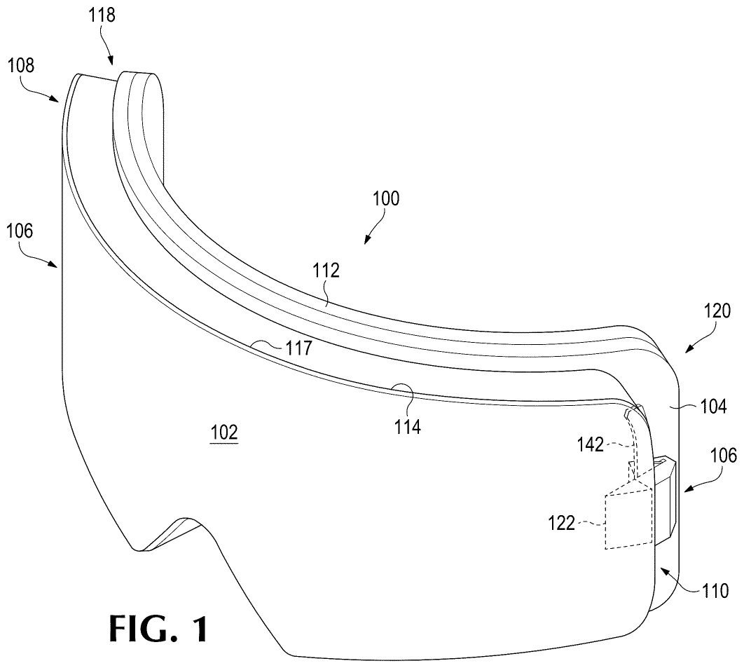

Referring to FIG. 1, goggles 100 having the quick lock and release attachment mechanism of the present disclosure is shown. The goggles include at least one lens 102, a goggles frame 104, and an attachment mechanism 106. The lens is shaped to partially wrap around a user's face and includes a recess to accommodate the user's nose. Additionally, lens 102 includes opposed longitudinal end portions 108 and 110. Lens 102 may be made from polycarbonate (PC), acrylic, or other suitable optical materials. In alternative embodiments, goggles 100 may include two lenses with a spacer disposed and attached between the two lenses, such as via adhesive or adhesive foam tape (not shown). In at least some of those alternative embodiments, the lenses may be received and supported in a lens frame (not shown).

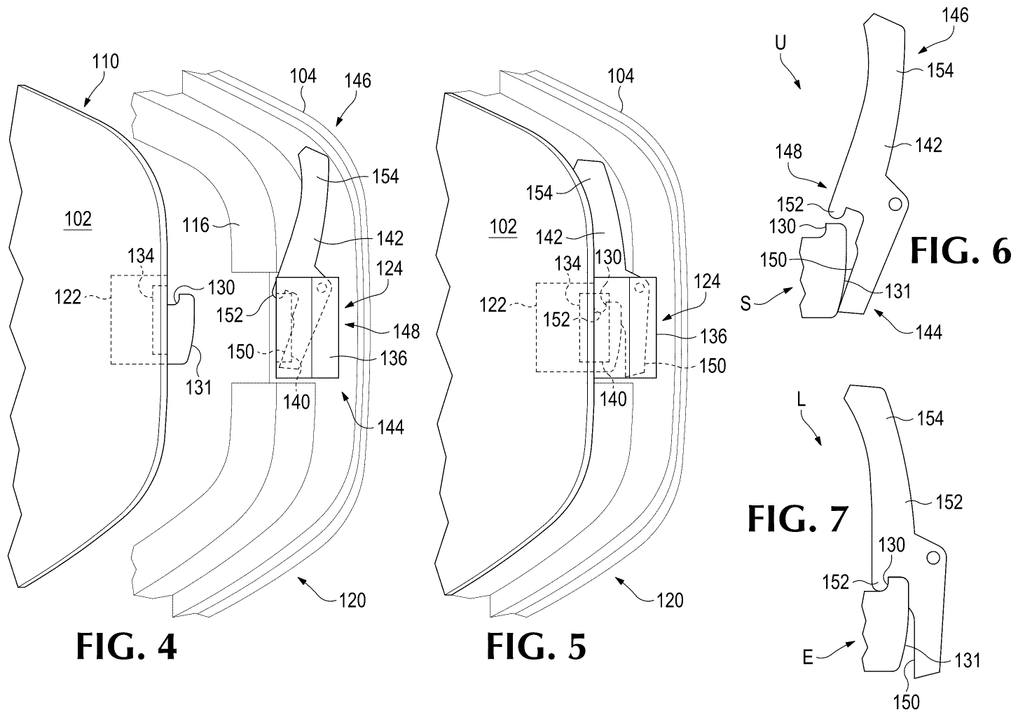

Goggles frame 104 includes a frame base 112 having an opening 114 to receive lens 102. The frame base is shaped substantially similar to the lens and includes an inner perimeter channel or inner perimeter surface 116 (as best shown in FIG. 4) that receives and/or supports at least a substantial portion or all of an outer perimeter 117 of lens 102 such that the lens (or outer lens when the goggles includes more than one lens 102) is substantially or completely flushed (or recessed) with the outer edges of the frame base. Frame base 112 further includes opposed longitudinal end portions 118 and 120 that correspond to longitudinal end portions 108 and 110 of lens 102. The frame base also includes end tabs with slots to receive goggles strap (not shown). Alternatively, outriggers (not shown) may be attached to longitudinal end portions 118 and 120 and those outriggers may each include slots for the strap.

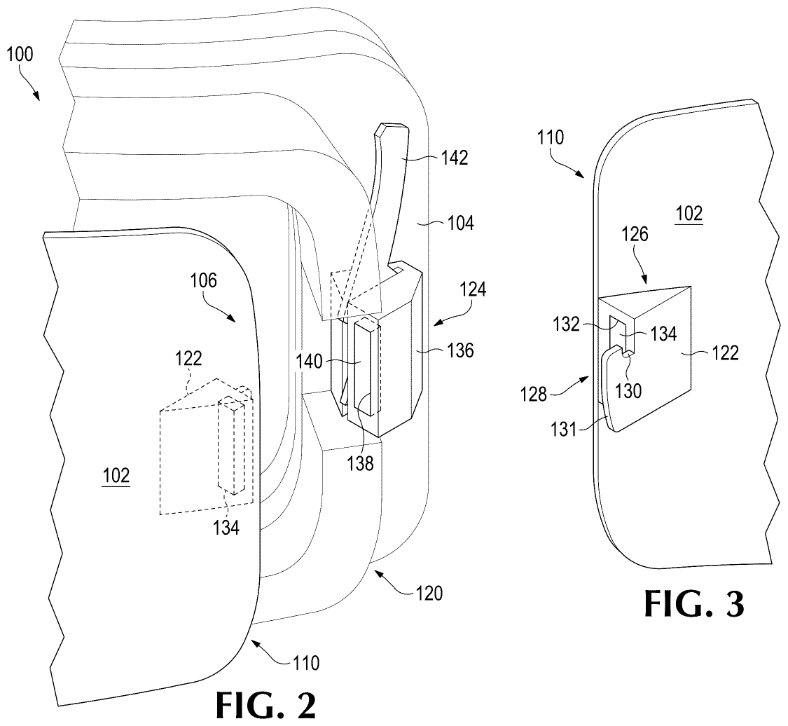

Referring to FIGS. 2-7, attachment mechanism 106 allows lens 102 to be removably secured to goggles frame 104, such as when lens 102 (e.g., most or all of outer perimeter 117) contacts and/or is supported on inner perimeter channel 116. Unless explicitly excluded, attachment mechanism 106 may include one or more components of other attachment mechanism(s) described in the present disclosure. The attachment mechanism may include a lens locking element 122 that is mechanically and/or magnetically engaged by a frame locking assembly 124. The lens locking element is directly and fixedly attached to each of end portions 108 and 110 of lens 102. When lens 102 includes two or more lenses, lens locking element 122 is directly and fixedly attached to, or formed with, the innermost lens (or the lens that contacts and/or is supported by inner perimeter channel 116). Lens locking element 122 may, for example, be incorporated in the lens molding process. Alternatively, the lens locking element may be fixedly attached via adhesive and/or one or more fasteners.

In the example shown in FIGS. 2-7, lens locking element 122 is a unitary component that extends generally perpendicular to lens 102. The lens locking element includes proximal 126 and distal 128 end portions with the proximal portion being formed with the lens and the distal end portion having a lens hook or hook portion 130 and a contact or ramp portion 131. Additionally, lens locking element 122 includes a cavity or hole 132 that receives a magnetic element 134. The magnetic element may be received in the cavity and fixedly attached to, or formed with, the lens locking element. For example, the magnetic element may be attached via one or more adhesives, or may be part of the molding process of the lens and the lens locking element. The cavity is positioned such that the magnetic element of the lens locking element faces toward the magnetic element of the frame locking element of the goggles frame (discussed below). In other words, the cavity is positioned so that the magnetic element is adjacent to the hook portion and spaced from the proximal portion of the lens locking element. The magnetic element may be a magnet and/or a metallic material. In other embodiments, the lens locking element may exclude the cavity or hole and the magnetic element may be attached (e.g., via one or more adhesives) to a portion or surface of the lens locking element.

Frame locking assembly 124 includes a locking base 136 fixedly attached to, or formed with, longitudinal end portions 118 and 120 of goggles frame 104. The locking base includes a cavity or hole 138 that receives a magnetic element 140. The magnetic element may be received in the cavity and fixedly attached to, or formed with, the locking base. For example, the magnetic element may be attached via one or more adhesives, or may be part of the molding process of the goggles and the locking base. The cavity is positioned such that the magnetic element of the locking base faces toward the magnetic element of the lens locking element of the lens. Magnetic element 140 may be a magnet and/or a metallic material (of reverse polarity if there is a magnet attached to or received in the above lens locking element). In other embodiments, the locking base may exclude cavity or hole 138 and magnetic element 140 may be attached to a portion or surface of the locking base.

The frame locking assembly further includes a frame locking element 142 that is movably attached to locking base 136. In the example shown in FIGS. 2-7, frame locking element 142 is pivotably attached to locking base 136 (such as via a pivot pin). The frame locking element includes proximal 144 and distal 146 end portions and an intermediate portion 148 disposed between those end portions. The proximal portion includes a ramp or lever portion 150, the intermediate portion includes a frame hook or hook portion 152, and the distal end portion includes a handle portion 154 that extends away from the goggles frame to allow a user access to the frame locking element.

In the example shown in FIGS. 2-7, the frame locking element moves among a plurality of positions relative to the locking base. For example, frame locking element 142 may move between a locking position L in which the frame locking element is adjacent to and/or mechanically engages the lens locking element, and an unlocking position U in which the frame locking element is spaced from the lens locking element (and does not mechanically engage the lens locking element) relative to the locking position. During the process of attachment of the lens to the goggles frame, the lens locking element moves between a supporting position S in which the lens (or at least portion or all of outer perimeter of the lens) is spaced from the goggles frame (or inner perimeter surface of the goggles frame) and/or the ramp portion of the lens locking element contacts the lever portion of the frame locking element but before the lens locking element moves the frame locking element, and an engaging position E in which the lens contacts or is supported on the goggles frame and the lens locking element moves the frame locking element into engagement with the lens locking element.

As a user attaches the lens to the goggles frame, ramp portion 131 of lens locking element 122 contacts lever portion 150 and pivots the frame locking element from the unlocking position to the locking position in which hook portion 152 mechanically engages with hook portion 130 to secure the lens to the goggles frame. The magnetic attraction between the magnetic elements associated with the lens locking element and the frame locking assembly may aid in both guiding the lens attachment process and also additional securing of the lens to the goggles frame. To detach the lens, the user can reach for the handle portion of the frame locking element and pivot the frame locking element from the locking position to the unlocking position, which allows the user to detach the lens from the goggle frame.

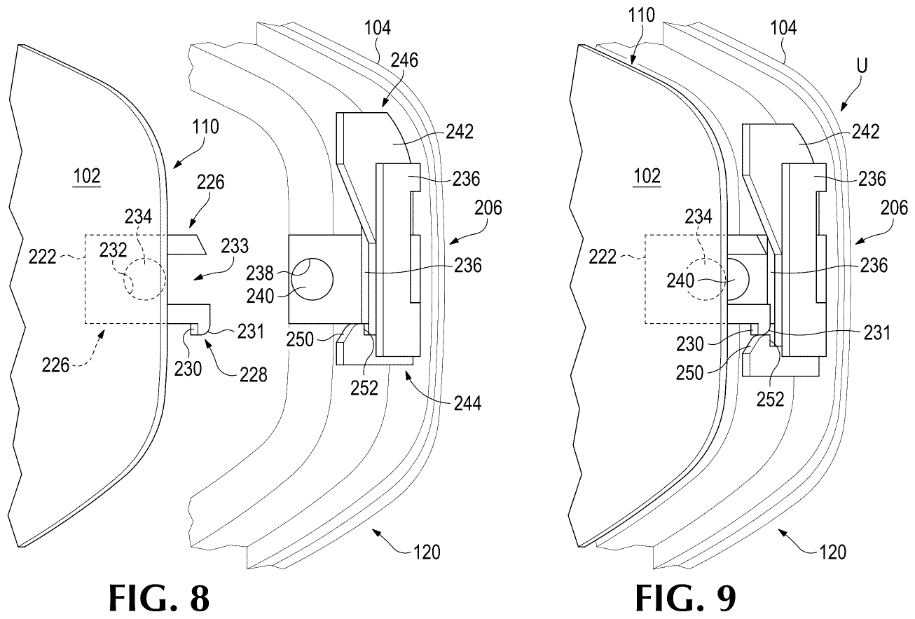

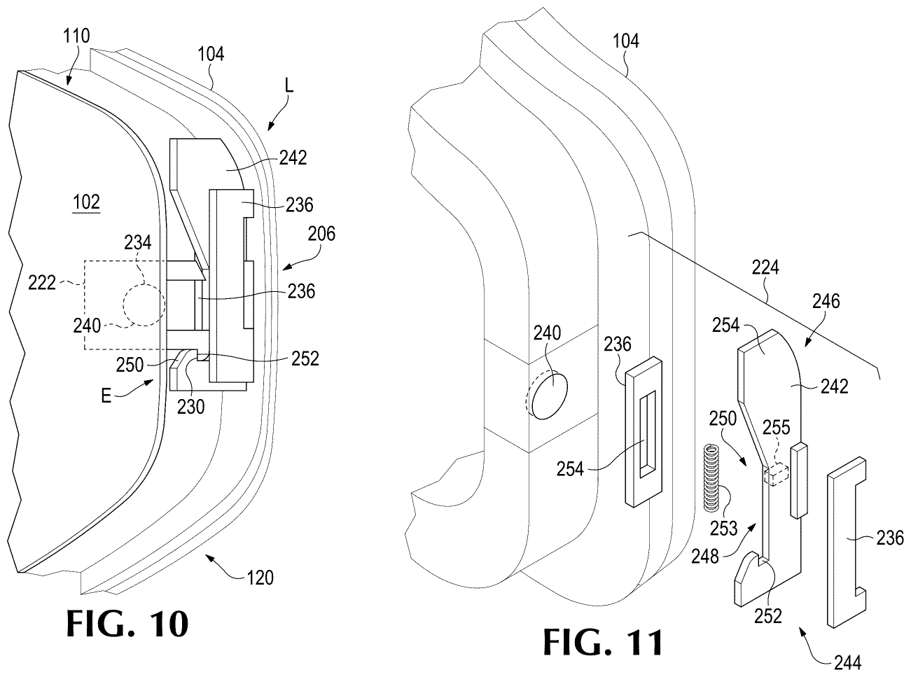

Referring to FIGS. 8-11, another embodiment of attachment mechanism 106 is shown and is generally indicated at 206. Unless explicitly excluded, attachment mechanism 206 may include one or more components of other attachment mechanism(s) described in the present disclosure. Similar to attachment mechanism 106, attachment mechanism 206 includes a lens locking element 222 that is mechanically and/or magnetically engaged by a frame locking assembly 224. The lens locking element is directly and fixedly attached to each of end portions 108 and 110 of lens 102. When lens 102 includes two or more lenses, lens locking element 222 is directly and fixedly attached to, or formed with, the innermost lens (or the lens that contacts and/or is supported by inner perimeter channel 116). Lens locking element 222 may, for example, be incorporated in the lens molding process. Alternatively, the lens locking element may be fixedly attached via adhesive and/or one or more fasteners.

In the example shown in FIGS. 8-11, lens locking element 222 is a unitary component that extends generally perpendicular to lens 102. Lens locking element is substantially similar to lens locking element 122. The lens locking element includes proximal 226 and distal 228 end portions with the proximal portion being formed with the lens and the distal end portion having a lens hook or hook portion 230 and a contact or ramp portion 231. Unlike lens locking element 122, lens locking element 222 includes a cavity or gap 233 disposed between the hook portion and the ramp portion. The presence of the gap provides a generally U-shaped lens locking element 222.

Additionally, lens locking element 222 includes a cavity or hole 232 that receives a magnetic element 234. The magnetic element may be received in the cavity and fixedly attached to, or formed with, the lens locking element. For example, the magnetic element may be attached via one or more adhesives, or may be part of the molding process of the lens and the lens locking element. The cavity is positioned such that the magnetic element of the lens locking element faces toward the magnetic element of the frame locking element of the goggles frame (discussed below). In other words, the cavity is positioned so that the magnetic element is adjacent to gap 233 and spaced from the proximal portion of the lens locking element. The magnetic element may be a magnet (of reverse polarity if there is a magnet attached to or received in the frame locking element) and/or a metallic material. In other embodiments, the lens locking element may exclude the cavity or hole and the magnetic element may be attached (e.g., via one or more adhesives) to a portion or surface of the lens locking element.

Frame locking assembly 224 includes a locking base 236 fixedly attached to, or formed with, longitudinal end portions 118 and 120 of goggles frame 104. The locking base includes a cavity or hole 238 that receives a magnetic element 240. The magnetic element may be received in the cavity and fixedly attached to, or formed with, the locking base. For example, the magnetic element may be attached via one or more adhesives, or may be part of the molding process of the goggles and the locking base. The cavity is positioned such that the magnetic element of the locking base faces toward the magnetic element of the lens locking element of the lens. In this case, the magnetic element is angled to face the magnetic element of the lens locking element as the user brings the lens and the lens locking element in proximity of locking base 236. Magnetic element 240 may be a magnet and/or a metallic material (of reverse polarity if there is a magnet attached to or received in the above lens locking element). In other embodiments, the locking base may exclude cavity or hole 238 and magnetic element 240 may be attached to a portion or surface of the locking base.

The frame locking assembly further includes a frame locking element 242 that is movably attached to locking base 236. In the example shown in FIGS. 8-11, frame locking element 242 is slidingly attached to locking base 236. The frame locking element includes proximal 244 and distal 246 end portions and an intermediate portion 248 disposed between those end portions. The proximal portion includes a ramp or lever portion 150 and a frame hook or hook portion 152, and the distal end portion includes a handle portion 154 that extends away from the goggles frame to allow a user access to the frame locking element. Intermediate portion 248 includes a gap 250 between the proximal and distal portions.

In the example shown in FIGS. 8-11, the frame locking element moves among a plurality of positions relative to the locking base. For example, frame locking element 242 may move between a locking position L in which the frame locking element is adjacent to and/or mechanically engages the lens locking element, and an unlocking position U in which the frame locking element is spaced from the lens locking element (and does not mechanically engage the lens locking element) relative to the locking position. The frame locking element is urged toward the locking position via one or more bias elements or springs 252, which is received in a channel 254 of the locking base. Frame locking element 242 includes a projection 255 that is also received in the channel to allow the spring to act on the frame locking element.

During the process of attachment of the lens to the goggles frame, the lens locking element moves between a supporting position S in which the lens (or at least portion or all of outer perimeter of the lens) is spaced from the goggles frame (or inner perimeter surface of the goggles frame) and/or the ramp portion of the lens locking element contacts the lever portion of the frame locking element but before the lens locking element moves the frame locking element, and an engaging position E in which the lens contacts or is supported on the goggles frame and the lens locking element moves the frame locking element into engagement with the lens locking element. Unlike the previous embodiment, the hook portion of the frame locking element blocks the path of the lens locking element from further movement toward the goggles frame when the lens locking element. In other words, without the ramp portion of the lens locking element and the lever portion of the frame locking element, the frame locking element would not be able to move to the engaging position because the frame locking element is in the path of the lens locking element. However, because of the ramp portion of the lens locking element and the lever portion of the frame locking element, as the lens locking element is moved from the supporting portion toward the engaging portion, the ramp portion of the lens locking element pushes on the lever portion of the frame locking element and moves the frame locking element temporarily into the unlocking position which opens the path for the lens locking element to move into the engaging position (and for the lens to contact and/or be supported on the goggles frame). Once the lens locking element moves into the engaging position, the bias element urges the frame locking element to the locking position such that the lens locking element and the frame locking element are in mechanical engagement.

As a user attaches the lens to the goggles frame, ramp portion 231 of lens locking element 222 contacts lever portion 250 and slides the frame locking element from the locking position to the unlocking position to allow the lens locking element to move to the engaging position. Once the lens contacts and/or is supported on the goggles frame, bias element 252 urges the frame locking element toward the locking position in which hook portion 252 mechanically engages with hook portion 230 to secure the lens to the goggles frame. The magnetic attraction between the magnetic elements associated with the lens locking element and the frame locking assembly may aid in both guiding the lens attachment process and also additional securing of the lens to the goggles frame. To detach the lens, the user can reach for the handle portion of the frame locking element and slide the frame locking element from the locking position to the unlocking position, which allows the user to detach the lens from the goggle frame.

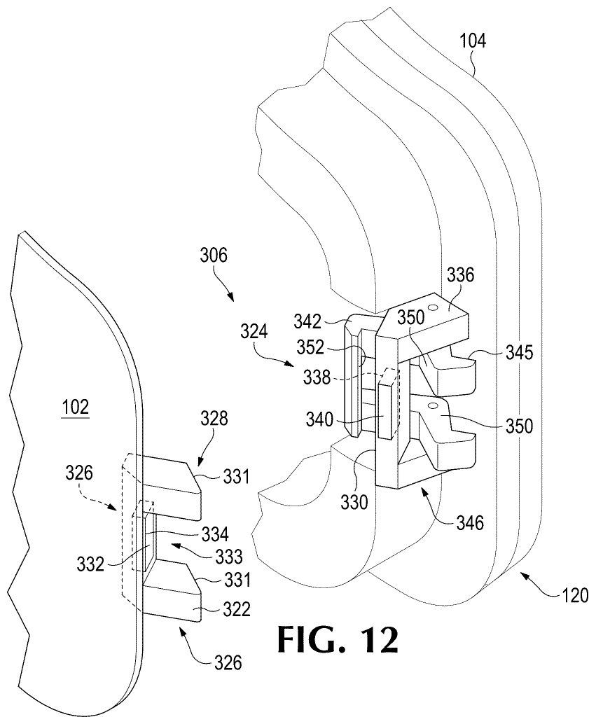

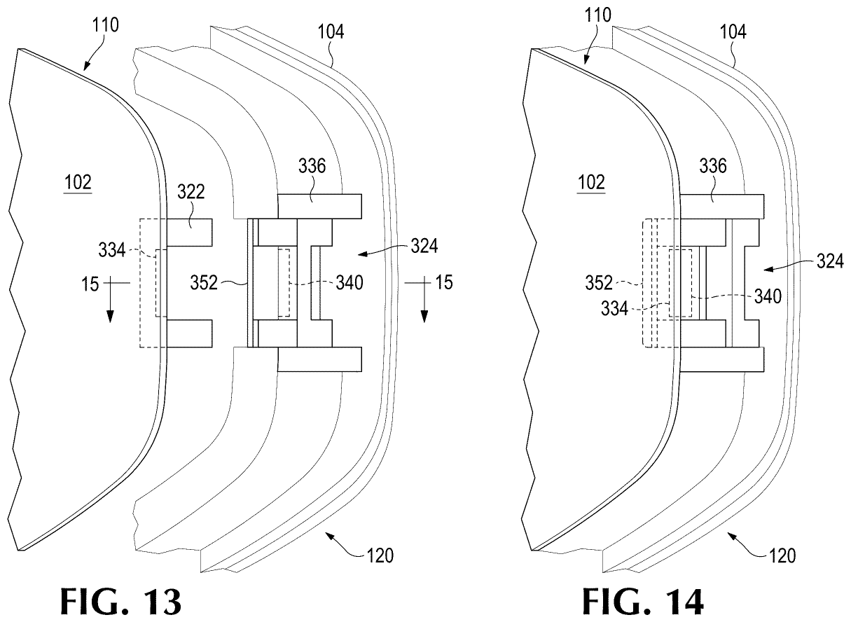

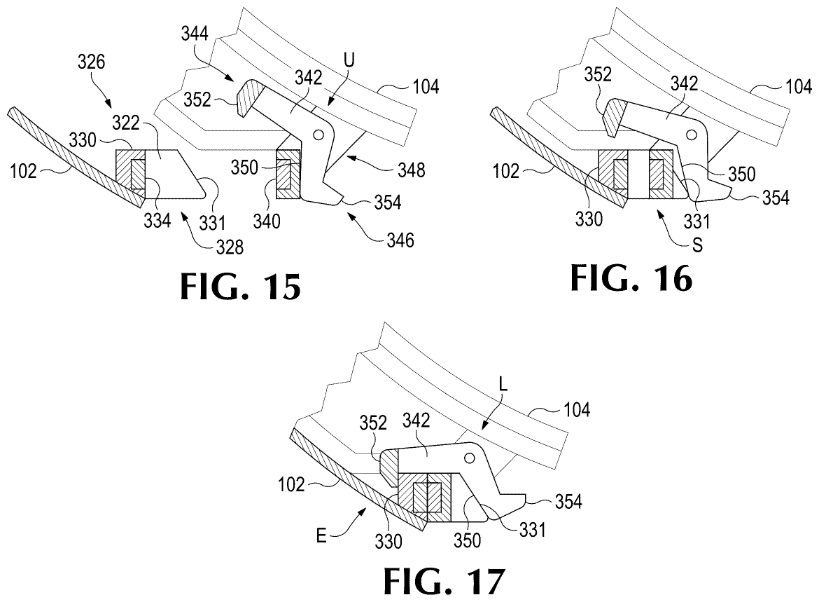

Referring to FIGS. 12-17, another embodiment of attachment mechanism 106 is shown and is generally indicated at 306. Unless explicitly excluded, attachment mechanism 306 may include one or more components of other attachment mechanism(s) described in the present disclosure. Similar to attachment mechanism 106, attachment mechanism 306 includes a lens locking element 322 that is mechanically and/or magnetically engaged by a frame locking assembly 324. The lens locking element is directly and fixedly attached to each of end portions 108 and 110 of lens 102. When lens 102 includes two or more lenses, lens locking element 322 is directly and fixedly attached to, or formed with, the innermost lens (or the lens that contacts and/or is supported by inner perimeter channel 116). Lens locking element 322 may, for example, be incorporated in the lens molding process. Alternatively, the lens locking element may be fixedly attached via adhesive and/or one or more fasteners.

In the example shown in FIGS. 12-17, lens locking element 322 is a unitary component that extends generally perpendicular to lens 102. Lens locking element 322 is substantially similar to one or more of the previous lens locking elements. The lens locking element includes proximal 326 and distal 328 end portions with the proximal portion being formed with the lens and having a locking shelf portion 330, while the distal end portion includes two ramp portions 331 separated by a cavity or gap 333. The presence of the gap provides a generally U-shaped lens locking element 322.

Additionally, lens locking element 322 includes a cavity or hole 332 that receives a magnetic element 334. The magnetic element may be received in the cavity and fixedly attached to, or formed with, the lens locking element. For example, the magnetic element may be attached via one or more adhesives, or may be part of the molding process of the lens and the lens locking element. The cavity is positioned such that the magnetic element of the lens locking element faces toward the magnetic element of the frame locking element of the goggles frame (discussed below). In other words, the cavity is positioned so that the magnetic element is adjacent to gap 333 and spaced from the proximal portion of the lens locking element. The magnetic element may be a magnet (of reverse polarity if there is a magnet attached to or received in the frame locking element) and/or a metallic material. In other embodiments, the lens locking element may exclude the cavity or hole and the magnetic element may be attached (e.g., via one or more adhesives) to a portion or surface of the lens locking element.

Frame locking assembly 324 includes a locking base 336 fixedly attached to, or formed with, longitudinal end portions 118 and 120 of goggles frame 104. The locking base includes a cavity or hole 338 that receives a magnetic element 340. The magnetic element may be received in the cavity and fixedly attached to, or formed with, the locking base. For example, the magnetic element may be attached via one or more adhesives, or may be part of the molding process of the goggles and the locking base. The cavity is positioned such that the magnetic element of the locking base faces toward the magnetic element of the lens locking element of the lens. In this case, the magnetic element is angled to face the magnetic element of the lens locking element as the user brings the lens and the lens locking element in proximity of locking base 336. Magnetic element 340 may be a magnet and/or a metallic material (of reverse polarity if there is a magnet attached to or received in the above lens locking element). In other embodiments, the locking base may exclude cavity or hole 338 and magnetic element 340 may be attached to a portion or surface of the locking base.

The frame locking assembly further includes a frame locking element 342 that is movably attached to locking base 336. In the example shown in FIGS. 12-17, frame locking element 342 is pivotably attached to locking base 336 (such as via a pivot pin). The frame locking element includes proximal 344 and distal 346 end portions and an intermediate portion 348 disposed between those end portions. The proximal portion includes a frame hook or hook portion 352, the intermediate portion includes a ramp or lever portion 350, and the distal end portion includes a handle portion 354 that extends away from the goggles frame to allow a user access to the frame locking element.

In the example shown in FIGS. 12-17, the frame locking element moves among a plurality of positions relative to the locking base. For example, frame locking element 342 may move between a locking position L in which the frame locking element is adjacent to and/or mechanically engages the lens locking element, and an unlocking position U in which the frame locking element is spaced from the lens locking element (and does not mechanically engage the lens locking element) relative to the locking position. During the process of attachment of the lens to the goggles frame, the lens locking element moves between a supporting position S in which the lens (or at least portion or all of outer perimeter of the lens) is spaced from the goggles frame (or inner perimeter surface of the goggles frame) and/or the ramp portion of the lens locking element contacts the lever portion of the frame locking element but before the lens locking element moves the frame locking element, and an engaging position E in which the lens contacts or is supported on the goggles frame and the lens locking element moves the frame locking element into engagement with the lens locking element.

As a user attaches the lens to the goggles frame, ramp portion 331 of lens locking element 322 contacts lever portion 350 and pivots the frame locking element from the unlocking position to the locking position in which hook portion 352 mechanically engages with locking shelf portion 330 to secure the lens to the goggles frame. The magnetic attraction between the magnetic elements associated with the lens locking element and the frame locking assembly may aid in both guiding the lens attachment process and also additional securing of the lens to the goggles frame. To detach the lens, the user can reach for the handle portion of the frame locking element and pivot the frame locking element from the locking position to the unlocking position, which allows the user to detach the lens from the goggle frame.

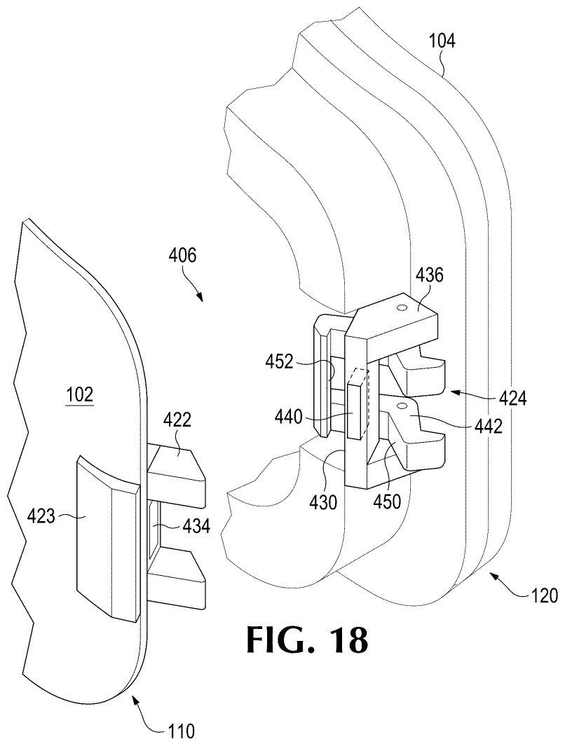

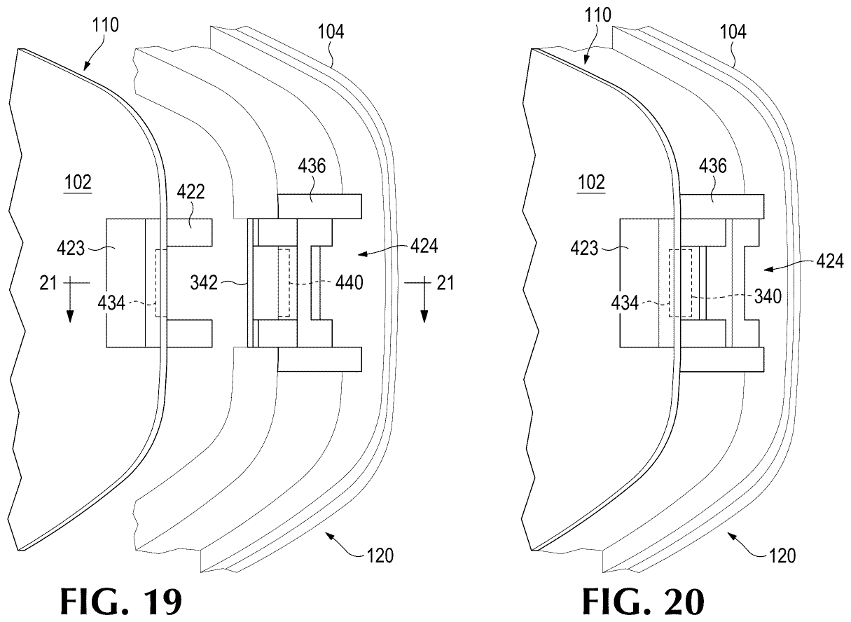

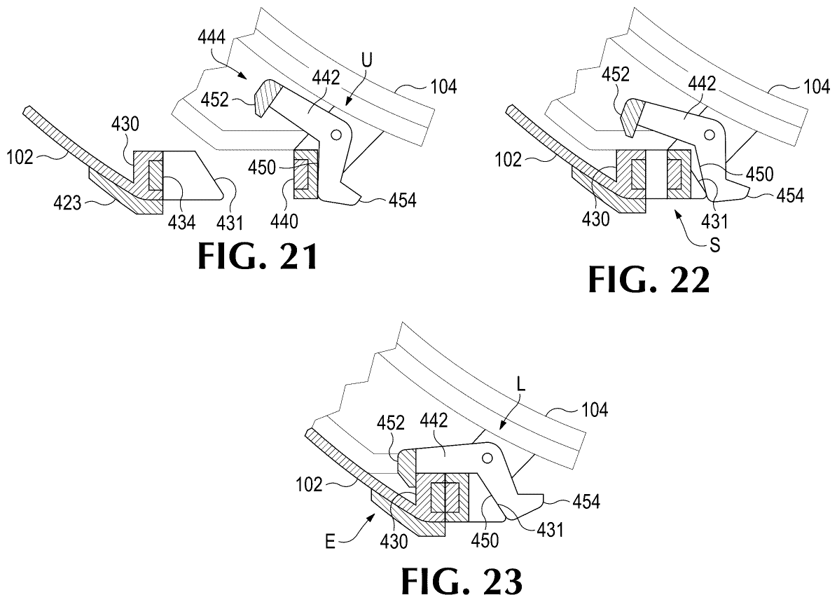

Referring to FIGS. 18-23, another embodiment of attachment mechanism 106 is shown and is generally indicated at 406. Unless explicitly excluded, attachment mechanism 406 may include one or more components of other attachment mechanism(s) described in the present disclosure. Attachment mechanism 406 is substantially identical to attachment mechanism 306 described above except that lens locking element 422 is not formed with lens 102. Instead, lens locking element 422 is directly and fixedly attached to each of end portions 108 and 110 of lens 102 via an outer plate 423 and fasteners 425. Components of attachment mechanism 406 that are the same or substantially the same as the components of attachment 306 are labeled accordingly in FIGS. 18-23. For example, lens locking element 422 is the same or substantially the same as lens locking element 322. Although only attachment mechanism 406 is shown to include lens locking elements that are directly and fixedly attached to the lens (such as via an outer plate and fasteners), the other attachment mechanisms of the present disclosure may include lens locking elements that are directly and fixedly attached to the lens.

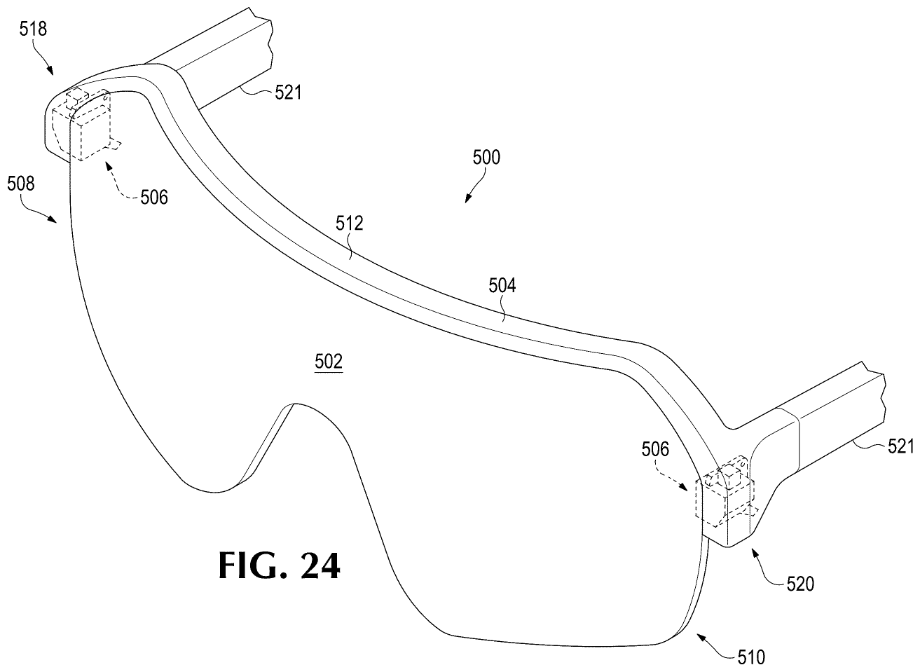

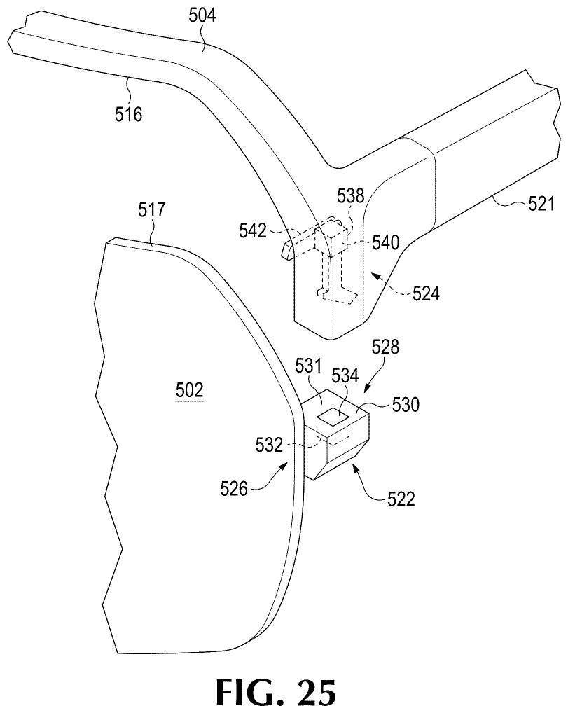

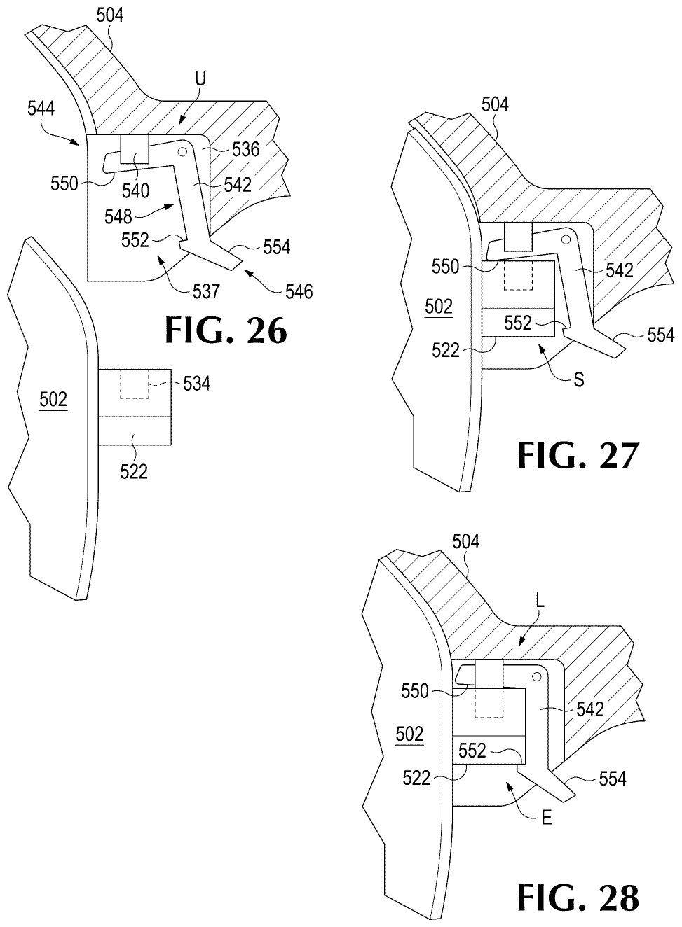

Referring to FIGS. 24-28, visor glasses 500 having the quick lock and release attachment mechanism of the present disclosure is shown. The goggles include at least one lens 502, a visor frame 504, and an attachment mechanism 506. The lens is shaped to partially wrap around a user's face and includes a recess to accommodate the user's nose. Additionally, lens 502 includes opposed longitudinal end portions 508 and 510. Lens 502 may be made from polycarbonate (PC), acrylic, or other suitable optical materials.

Visor frame 504 includes a frame base 512 that is shaped substantially similar to a top portion of the lens and includes an inner perimeter channel or inner perimeter surface 516 that receives and/or is supported on at least a substantial portion or all of a top outer perimeter 517 of lens 102 such that the lens is substantially or completely flushed (or recessed) with the outer edges of the frame base. Frame base 512 further includes opposed longitudinal end portions 518 and 520 that correspond to longitudinal end portions 508 and 510 of lens 502. The visor frame also includes temple arms 521 that are pivotably attached to end portions 518 and 520 of frame base 512.

Attachment mechanism 506 allows lens 502 to be removably secured to visor frame 504, such as when lens 502 (e.g., most or all of top outer perimeter 517) contacts and/or is supported on inner perimeter channel 516. Unless explicitly excluded, attachment mechanism 506 may include one or more components of other attachment mechanism(s) described in the present disclosure. The attachment mechanism may include a lens locking element 522 that is mechanically and/or magnetically engaged by a frame locking assembly 524. The lens locking element is directly and fixedly attached to each of end portions 508 and 510 of lens 502, such as via fasteners and/or adhesive(s).

In the example shown in FIGS. 24-28, lens locking element 522 is a unitary component that extends generally perpendicular to lens 502. The lens locking element includes proximal 526 and distal 528 end portions with the proximal portion being fixedly attached to, or formed with, the lens and the distal end portion having a locking shelf 530 and a contact or ramp portion 531. Additionally, lens locking element 522 includes a cavity or hole 532 that receives a magnetic element 534. The magnetic element may be received in the cavity and fixedly attached to, or formed with, the lens locking element. For example, the magnetic element may be attached via one or more adhesives, or may be part of the molding process of the lens and the lens locking element. The cavity is positioned such that the magnetic element of the lens locking element faces toward the magnetic element of the frame locking element of the visor frame (discussed below). In other words, the cavity is positioned so that the magnetic element is adjacent to the hook portion and spaced from the proximal portion of the lens locking element. The magnetic element may be a magnet and/or a metallic material. In other embodiments, the lens locking element may exclude the cavity or hole and the magnetic element may be attached (e.g., via one or more adhesives) to a portion or surface of the lens locking element.

Frame locking assembly 524 includes a locking base 536 fixedly attached to, or formed with, longitudinal end portions 518 and 520 of visor frame 504. The locking base includes a cavity or hole 538 that receives a magnetic element 540. The magnetic element may be received in the cavity and fixedly attached to, or formed with, the locking base. For example, the magnetic element may be attached via one or more adhesives, or may be part of the molding process of the goggles and the locking base. The cavity is positioned such that the magnetic element of the locking base faces toward the magnetic element of the lens locking element of the lens. Magnetic element 540 may be a magnet and/or a metallic material (of reverse polarity if there is a magnet attached to or received in the above lens locking element). In other embodiments, the locking base may exclude cavity or hole 538 and magnetic element 540 may be attached to a portion or surface of the locking base.

The frame locking assembly further includes a frame locking element 542 that is movably attached to locking base 536. In the example shown in FIGS. 24-28, frame locking element 542 is pivotably attached to locking base 536 (such as via a pivot pin). The frame locking element includes proximal 544 and distal 546 end portions and an intermediate portion 548 disposed between those end portions. The proximal portion includes a ramp or lever portion 550, the intermediate portion includes a frame hook or hook portion 552, and the distal end portion includes a handle portion 554 that extends away from the visor frame to allow a user access to the frame locking element.

In the example shown in FIGS. 24-28, the frame locking element moves among a plurality of positions relative to the locking base. For example, frame locking element 542 may move between a locking position L in which the frame locking element is adjacent to and/or mechanically engages the lens locking element, and an unlocking position U in which the frame locking element is spaced from the lens locking element (and does not mechanically engage the lens locking element) relative to the locking position. During the process of attachment of the lens to the visor frame, the lens locking element moves between a supporting position S in which the lens (or at least portion or all of top outer perimeter 517 of the lens) is spaced from the visor frame (or inner perimeter surface 516 of the visor frame) and/or the ramp portion of the lens locking element contacts the lever portion of the frame locking element but before the lens locking element moves the frame locking element, and an engaging position E in which the lens contacts or is supported on the visor frame and the lens locking element moves the frame locking element into engagement with the lens locking element.

As a user attaches the lens to the visor frame, ramp portion 531 of lens locking element 522 contacts lever portion 550 and pivots the frame locking element from the unlocking position to the locking position in which hook portion 552 mechanically engages with locking shelf 530 to secure the lens to the visor frame. The magnetic attraction between the magnetic elements associated with the lens locking element and the frame locking assembly may aid in both guiding the lens attachment process and also additional securing of the lens to the visor frame. To detach the lens, the user can reach for the handle portion of the frame locking element and pivot the frame locking element from the locking position to the unlocking position, which allows the user to detach the lens from the visor frame.

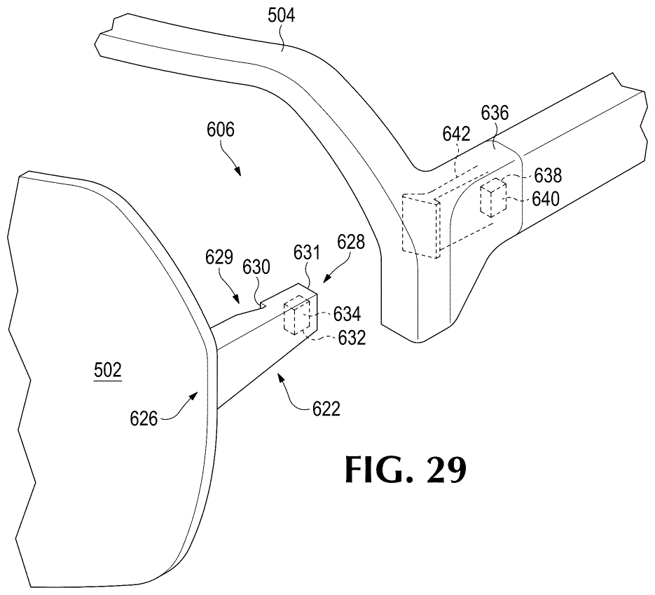

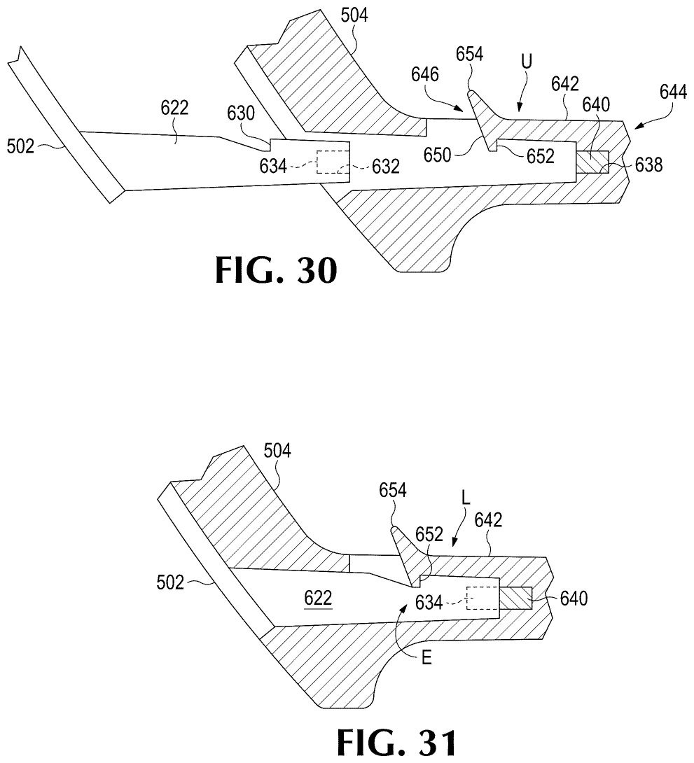

Referring to FIGS. 29-31, another embodiment of attachment mechanism 506 is shown and is generally indicated at 606. Unless explicitly excluded, attachment mechanism 606 may include one or more components of other attachment mechanism(s) described in the present disclosure. Similar to attachment mechanism 506, attachment mechanism 606 includes a lens locking element 622 that is mechanically and/or magnetically engaged by a frame locking assembly 624. The lens locking element is directly and fixedly attached to each of end portions 508 and 510 of lens 502, such as via fasteners and/or adhesive(s).

In the example shown in FIGS. 29-31, lens locking element 622 is a unitary component that extends generally perpendicular to lens 502. The lens locking element includes proximal 626 and distal 628 end portions and an intermediate portion disposed between the proximal and distal end portions. The proximal end portion is fixedly attached to (or formed with) the lens, the intermediate portion includes a locking shelf or recess 630, and the distal end portion includes a contact or ramp portion 631. Additionally, lens locking element 622 includes a cavity or hole 632 that receives a magnetic element 634. The magnetic element may be received in the cavity and fixedly attached to, or formed with, the lens locking element. For example, the magnetic element may be attached via one or more adhesives, or may be part of the molding process of the lens and the lens locking element. The cavity is positioned such that the magnetic element of the lens locking element faces toward the magnetic element of the frame locking element of the visor frame (discussed below). In other words, the cavity is positioned so that the magnetic element is adjacent to the distal end and spaced from the proximal end portion of the lens locking element. The magnetic element may be a magnet and/or a metallic material. In other embodiments, the lens locking element may exclude the cavity or hole and the magnetic element may be attached (e.g., via one or more adhesives) to a portion or surface of the lens locking element.

Frame locking assembly 624 includes a locking base 536 attached to, or formed with, longitudinal end portions 518 and 520 of visor frame 504. The locking base includes a cavity or hole 638 that receives a magnetic element 640. The magnetic element may be received in the cavity and fixedly attached to, or formed with, the locking base. For example, the magnetic element may be attached via one or more adhesives, or may be part of the molding process of the visor frame and the locking base. The cavity is positioned such that the magnetic element of the locking base faces toward the magnetic element of the lens locking element of the lens. Magnetic element 640 may be a magnet and/or a metallic material (of reverse polarity if there is a magnet attached to or received in the above lens locking element). In other embodiments, the locking base may exclude cavity or hole 638 and magnetic element 640 may be attached to a portion or surface of the locking base.

The frame locking assembly further includes a frame locking element 642 that is movably attached to locking base 636. In the example shown in FIGS. 29-31, frame locking element 642 is formed with locking base 636 with a certain amount of flexibility to allow the frame locking element to move relative to the locking base. The frame locking element includes proximal 644 and distal 646 end portions. The proximal end portion is formed with the locking base and the distal end portion includes a ramp or lever portion 650, a frame hook or hook portion 652, and a handle portion 654 that extends away from the visor frame to allow a user access to the frame locking element. The frame locking element is a form of a cantilever that creates a cantilever snap-fit joint with the lens locking element.

In the example shown in FIGS. 29-31, the frame locking element moves, deflects, or flexes among a plurality of positions relative to the locking base. For example, frame locking element 642 may move between a locking position L in which the frame locking element is adjacent to and/or mechanically engages the lens locking element, and an unlocking position U in which the frame locking element is spaced from the lens locking element (and does not mechanically engage the lens locking element) relative to the locking position. During the process of attachment of the lens to the visor frame, the lens locking element moves between a supporting position S in which the lens (or at least portion or all of top outer perimeter 517 of the lens) is spaced from the visor frame (or inner perimeter surface 516 of the visor frame) and/or the ramp portion of the lens locking element contacts the lever portion of the frame locking element but before the lens locking element moves the frame locking element, and an engaging position E in which the lens contacts or is supported on the visor frame and the lens locking element moves the frame locking element into engagement with the lens locking element.

During the process of attachment of the lens to the visor frame, the lens locking element moves between a supporting position S in which the lens (or at least portion or all of top outer perimeter 517 of the lens) is spaced from the visor frame (or inner perimeter surface 516 of the visor frame) and/or the ramp portion of the lens locking element contacts the lever portion of the frame locking element but before the lens locking element moves the frame locking element, and an engaging position E in which the lens contacts or is supported on the visor frame and the lens locking element moves the frame locking element into engagement with the lens locking element. Unlike the previous embodiment, the hook portion of the frame locking element blocks the path of the lens locking element from further movement toward the visor frame when the lens locking element is in the supporting position. In other words, without the ramp portion of the lens locking element and the lever portion of the frame locking element, the frame locking element would not be able to move to the engaging position because the frame locking element is in the path of the lens locking element. However, because of the ramp portion of the lens locking element, the inherent flex of the frame locking element, and the lever portion of the frame locking element, as the lens locking element is moved from the supporting portion toward the engaging portion, the ramp portion of the lens locking element pushes on the lever portion of the frame locking element and moves the frame locking element temporarily into the unlocking position which opens the path for the lens locking element to move into the engaging position (and for the lens to contact and/or be supported on the visor frame). Once the lens locking element moves into the engaging position, the frame locking element moves or flexes back to the locking position such that the lens locking element and the frame locking element are in mechanical engagement.

As a user attaches the lens to the visor frame, ramp portion 631 of lens locking element 622 contacts lever portion 650 and deflects or flexes the frame locking element from the locking position to the unlocking position to allow the lens locking element to be moved from the supporting position to the engaged position in which hook portion 652 mechanically engages with locking shelf or groove 630 to secure the lens to the visor frame. The magnetic attraction between the magnetic elements associated with the lens locking element and the frame locking assembly may aid in both guiding the lens attachment process and also additional securing of the lens to the visor frame. To detach the lens, the user can reach for the handle portion of the frame locking element and deflect or flex the frame locking element from the locking position to the unlocking position, which allows the user to detach the lens from the visor frame.

Although particular combinations of lens and frame locking elements are shown for each embodiment, other embodiments may include any suitable combination of lens and frame locking elements. Additionally, one or more examples of the attachment mechanisms of the present disclosure may include lens and frame locking assemblies that are the opposite of that shown in the present disclosure. In other words, the lens locking element may have structural components of the frame locking assembly of the present disclosure instead of the structural components of the lens locking element, and vice-versa. For example, the lens locking element may include a cantilever having a hook portion and the frame locking element may include the groove shaped to at least partially receive the hook portion. Moreover, one or more embodiments of the present disclosure may exclude the magnetic elements attached to, or formed with, the lens locking element and/or the frame locking element. Furthermore, the magnetic elements, when present, may be any suitable shape(s), such as rectangular prism or a trapezoidal prism. Additionally, one or more covers may be attached to, or formed with, the magnetic elements (instead of having one or more faces exposed).

The lens attachment mechanisms described in the present disclosure enhance user convenience and versatility and are applicable to a broad range of eyewear. The mechanism offers a quick lock and release feature that optimizes user experience. Materials like high-strength polymers or lightweight metals are used for construction, ensuring both durability and comfort.

The design includes a user-friendly locking mechanism with magnets, metal inserts, locking tabs, and locking shelves, allowing for easy lens interchange, switching, or cleaning. A lever or push mechanism facilitates lens detachment, while aligning the lens ensures secure reattachment. Magnets guide the lens into alignment with the frame or temple arms, simplifying the attachment process.

In alternative embodiments, a push mechanism can replace the lever, offering another option for lens detachment. The locking mechanism can also eliminate levers or push mechanisms, relying on material properties for secure connections. Materials like rubber, silicone, thermoplastic elastomers (TPE), memory polymers, or soft rubber compounds provide flexibility and resilience for this purpose.

The lens attachment mechanism offers material choices like high-strength polymers or lightweight metals for lens components, durable plastics or composite materials for locking shelves, and flexible yet durable plastics or lightweight metals for temple arms or frames. Elastic headbands can use materials like silicone, neoprene, elastic fabric, nylon, and more, ensuring functionality and comfort across various applications.

In addition to the foregoing description, it is to be understood that various embodiments and modifications of the invention may be readily apparent to those skilled in the art without departing from the spirit or scope of the present invention. Accordingly, the appended materials, which may include additional embodiments, are provided to further illustrate and describe various aspects and embodiments of the invention. Furthermore, it should be noted that any dimensions that may be provided in the drawings or the appendix are intended to be purely illustrative and not necessarily to scale, serving primarily as aids to comprehension rather than precise measurements.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

What is claimed is:

1. Eyewear, comprising:
a lens having opposed first and second end portions;
a lens locking element fixedly attached to, or formed with, at least one of the first and second end portions;
a frame having opposed third and fourth end portions that correspond to the first and second end portions of the at least one lens, the frame having at least one surface that contacts at least a portion of a perimeter of the lens; and
a frame locking assembly including:
a locking base attached to, or formed with, at least one of the third and fourth end portions, and
a frame locking element that moves relative to the locking base, wherein the lens locking element and the frame locking assembly are positioned such that, when the at least a portion of a perimeter of the lens contacts the at least one surface, the frame locking element mechanically engages the lens locking element to removably secure the lens to the frame.

2. The eyewear of claim 1, wherein the lens locking element includes a lens hook or a locking shelf.

3. The eyewear of claim 1, wherein the frame locking element is pivotably attached to the locking base, the frame locking element having a handle portion that extends away from the frame.

4. The eyewear of claim 3, wherein the frame locking element includes a ramp portion opposite the handle portion, the frame locking element being positioned such that, when the lens is brought into contact with the at least one surface, the lens locking element moves the ramp portion of the frame locking element and pivots the frame locking element toward mechanical engagement with the lens locking element.

5. The eyewear of claim 1, wherein the frame locking element is slidingly attached to the locking base to allow the frame locking element to move between a locking position in which the frame locking element is adjacent to the lens locking element, and an unlocking position in which the frame locking element is spaced from the lens locking element relative to the locking position.

6. The eyewear of claim 1, wherein the lens locking element includes a lens hook and the frame locking element includes a frame hook.

7. The eyewear of claim 6, wherein the frame locking assembly further includes a bias element that urges the frame locking element toward the locking position.

8. The eyewear of claim 6, wherein the lens hook is movable between a supporting position in which the at least a portion of a perimeter of the lens is spaced from the at least one surface and the lens hook contacts the frame hook in the locking position and, and an engaging position in which the at least a portion of a perimeter of the lens contacts the at least one surface, wherein the frame hook mechanically engages the lens hook when the frame hook is in the locking position and the lens hook is in the engaging position.

9. The eyewear of claim 8, wherein the frame hooks includes a ramp portion that is shaped such that, when the lens hook is moved from the supporting position toward the engaging position, the lens hook contacts the ramp portion and moves the frame hook from the locking position to the unlocking position allowing the at least a portion of a perimeter of the lens to contact the at least one surface and the frame hook to move to the locking position when the at least a portion of a perimeter of the lens contacts the at least one surface.

10. The eyewear of claim 1, wherein the frame locking element is pivotably or slidingly attached to the locking base.

11. The eyewear of claim 1, wherein the frame locking element includes a deflectable locking hook formed with the locking base and the lens locking element includes a groove shaped to receive the locking hook.

12. The eyewear of claim 1, further comprising first and second temples pivotably attached to the third and fourth end portions of the frame.

13. The eyewear of claim 1, wherein the at least one surface contacts at least a substantial portion of the perimeter of the lens.

14. The eyewear of claim 13, wherein the frame includes a channel having the at least one surface.

15. The eyewear of claim 1, further comprising:
a first magnetic member fixedly attached to, or formed with, the lens locking element; and
a second magnetic member fixedly attached to, or formed with, the locking base, wherein the lens locking element and the frame locking assembly are positioned such that, when the at least a portion of the perimeter of the lens contacts the at least one surface, the first and second magnetic members are adjacent to each other and the frame locking element mechanically engages the lens locking element to removably secure the lens to the frame.

16. The eyewear of claim 1, wherein the lens locking element includes a first hole and the first magnetic member is received in the first hole.

17. The eyewear of claim 16, wherein the locking base includes a second hole and the second magnetic member is received in the second hole.

18. Goggles, comprising:
at least one lens having opposed first and second end portions;
a lens locking element directly and fixedly attached to each of the first and second end portions;
a first magnetic member fixedly attached to the lens locking element;
a frame having opposed third and fourth end portions that correspond to the first and second end portions of the at least one lens, the frame having at least one surface that contacts at least a substantial portion of a perimeter of the lens; and
a frame locking assembly including:
a locking base attached to at least one of the third and fourth end portions,
a second magnetic member fixedly attached to the locking base, and
a frame locking element that is movably attached to the locking base, wherein the lens locking element and the frame locking assembly are positioned such that, when the at least a portion of a perimeter of the lens contacts the at least one surface, the first and second magnetic members are adjacent to each other and the frame locking element mechanically engages the lens locking element to removably secure the lens to the frame.

19. Visor glasses, comprising
a lens having opposed first and second end portions;
a lens locking element directly and fixedly attached to each of the first and second end portions;
a first magnetic member fixedly attached to the lens locking element;
a frame having opposed third and fourth end portions that correspond to the first and second end portions of the at least one lens, the frame having at least one surface that contacts at least a portion of a perimeter of the lens;
a first temple pivotably attached to the third end portion of the frame;
a second temple pivotably attached to the fourth end portion of the frame; and
a frame locking assembly including:
a locking base attached to each of the third and fourth end portions,
a second magnetic member fixedly attached to the locking base, and
a frame locking element that is movably attached to the locking base, wherein the lens locking element and the frame locking assembly are positioned such that, when the at least a portion of a perimeter of the lens contacts the at least one surface, the first and second magnetic members are adjacent to each other and the frame locking element mechanically engages the lens locking element to removably secure the lens to the frame.
